(19) United States
(12) Patent Application Publication
(10) Pub. No.: US 2017/0072840 A1
(43) Pub. Date: Mar. 16, 2017

(54) HELMET WITH TURN SIGNAL INDICATORS

(71) Applicants: Arvin MossadeghPour, East Windsor, NJ (US); Masoud Davari Dolatabadi, Aachen (DE)

(72) Inventors: Arvin MossadeghPour, East Windsor, NJ (US); Masoud Davari Dolatabadi, Aachen (DE)

(21) Appl. No.: 15/262,589

(22) Filed: Sep. 12, 2016

Related U.S. Application Data
(60) Provisional application No. 62/217,098, filed on Sep. 11, 2015.

(51) Int. Cl. B60Q 1/26; B60Q 1/00; A42B 3/04; G01C 21/26; H04W 4/22; A42B 3/30; B60Q 1/34; B60K 28/06

(52) U.S. Cl. CPC B60Q 1/2676; B60Q 1/343; B60Q 1/346; B60Q 1/0076; B60K 28/066; G01C 21/265; H04W 4/22; A42B 3/306; A42B 3/042; A42B 3/046

(57) ABSTRACT

A helmet with a turn signal display system, comprising one or more displays for illumination, a power source unit configured to provide power to the one or more displays, a control unit configured to control the one or more display. The helmet further comprises a luminous sensing unit, a tilt calculator unit, and an analyzer unit. The luminous sensing unit measures outdoor lighting conditions and provides a feedback signal to the control unit. The tilt calculator unit configured to calculate a tilt angle between axes of a vehicle to a surface and sends one or more data on the tilt angle to the control unit. The analyzer unit configured to process one or more neuron behaviors of a user, and provides the one or more neural activities to the control unit. The control unit generates an output signal via the one or more display.

### CROSS REFERENCE TO RELATED APPLICATIONS

This application claims priority to U.S. Provisional Patent Application No. 62/217,098, filed in the United States Patent and Trademark Office on Sep. 11, 2015. The specification of the above referenced patent application is incorporated herein by reference in its entirety.

### BACKGROUND OF THE INVENTION

A. Technical field

The present invention generally relates to the technical field safety equipment such as a helmet, and more specifically relates to the helmet with turn signal indicators to indicate direction of a vehicle.

B. Description of related art

In recent years, vehicle accidents are among the leading causes of injury and death. Many of these accidents, injuries and deaths that occur can be attributed to inadequate reaction time by other motorists. Further, failure of others to recognize intent to turn in either direction, particularly under bad light condition, may cause a significant safety hazard both to such other persons and to the users of the vehicle in question. The severity of the accident could usually be reduced, if there was just a few more seconds of braking time available. Accordingly, a need exists for a means by which motorists following motorcycles can be afforded more braking reaction time.

Yu-Lin Chung., U.S. Pat. No 6,914,520 describes a helmet-warning device. The warning device as disclosed in the patent is disposed on the helmet with functions of both direction and safety signaling, like third brake light of vehicle. It assures the safety of the user and prevents traffic accidents. However, this patent does not appear to disclose a method that provides more braking reaction time for the motorists.

William Scott Whiting., U.S. Pat. No 6,406,168 discloses a helmet mounted brake light. The motorcycle helmet lighting system as disclosed is capable of establishing wireless links between a transmitter mounted on a motorcycle and motorcycle helmet. However, this approach may be restricted by the inability to provide more braking reaction time for the motorists.

Richard T. Lord., U.S. Pat. No 9,107,012 discloses a method of vehicular threat detection based on audio signals. The disclosed method determines poor surface conditions exist on a road traveled by the user by considering weather conditions, temperature, road surface type, and foreign materials on the road. The method further displays vehicular threat information via a visual display device and/or an audio output device of a wearable device of the user by presenting a visual and/or audio message directing the user to accelerate, decelerate, or turn. However, this patent does not disclose with turn signal indicators for illuminating indications of a vehicle's direction.

Therefore, there is a need in the art for a helmet with turn signal indicator to indicate direction of vehicles.

### SUMMARY OF THE INVENTION

The present invention relates to a helmet with a turn signal display system. The helmet comprising a left turn signal display, a right turn signal display, a front signal display, a rear signal display, a power source unit, a control unit, a luminous sensing unit, a tilt calculation unit, and an analyzer unit. The left turn signal display is located to the rear left end of the helmet. The right turn signal display is located to the rear right end of the helmet. The front signal display is located to the frontal part of the helmet. The rear signal display is located to the rear part of the helmet. In an embodiment, the left turn signal display, the right turn signal display, the front signal display and the rear signal display comprises an illumination means. The illumination means comprises, but not limited to, a light emitting diode (LED), a light amplification by stimulated emission of radiation lamp (LASER), a bulb, or an incandescent lamp. The power source unit is configured to provide power to the left turn signal display, the right turn signal display, the front signal display and the rear signal display.

The control unit is configured to control the left turn signal display, the right turn signal display, the front signal display and the rear signal display. The luminous sensing unit measures outdoor lighting conditions and provides a feedback signal to the control unit, wherein the control unit generates an output signal via the front signal display and the rear signal display based on the feedback signal. In an embodiment, the luminous sensing unit is operationally connected to the control unit. For example, the control unit turns on the front signal display and the rear signal display when the outdoor lighting condition is poor, wherein the control unit turns off the front signal display and the rear signal display when the outdoor lighting condition is good.

The tilt calculator unit is configured to calculate a tilt angle between axes of a vehicle to a surface. The tilt calculator unit sends one or more data on the tilt angle to the control unit through a feedback signal. The control unit generates an output signal via the left turn signal display and the right turn signal display based on the feedback signal. In an embodiment, the tilt calculator unit comprise one or more sensors to calculate the tilt angle. When a user tilts the vehicle towards the left of the surface, the tilt calculator unit calculates the tilt angle and sends the one or more data on the tilt angle to the control unit generates an output signal via the left turn signal display.

The analyzer unit is configured to process one or more neuron behaviors of the user. The analyzer unit comprises a plurality of sensors to sense one or more neural activities of the user brain, and provides the one or more neural activities to the control unit generates an output signal via the left turn signal display and the right turn signal display. In one embodiment, the analyzer unit is configured to measure real time electroencephalography (EEG) data of the user brain. The electroencephalography (EEG) measures voltage fluctuations resulting from ionic current within the neurons of the user brain. In an embodiment, the electroencephalography (EEG) comprise sensors/electrodes to measure electrical activities of the user brain. an embodiment, the plurality of sensors of the analyzer unit measures one or more brainwaves of the user brain and transmits at least two brainwaves to the control unit that converts the brainwaves into a format usable by a signal processor. The signal processor analyzes the brainwaves and sends a trigger signal to the control unit generates an output signal via the left turn signal display and the right turn signal display. The trigger signal is based on the intensity of the brainwaves of the user. In an embodiment, the brainwaves associated with a particular mental or physical state of the user are classified to identify the particular mental or physical state of the user, and generates an alarm signal to notify the user.

The helmet further comprises an accelerometer unit operationally coupled to the control unit. The accelerometer unit measures the acceleration of the vehicle and sends a feedback signal to the control unit. In an embodiment, the feedback signal is information on speed of the vehicle and information of braking condition of the vehicle. The control unit generates an output signal via the rear signal display, if the accelerometer unit measures the braking conditions of the vehicle.

The helmet further comprises a gesture sensing unit is operationally coupled to the control unit. The gesture sensing unit senses different gestures of the user and provides a feedback signal to the control unit generates an output signal via the left turn signal display and the right turn signal display. In an embodiment, the feedback signal is a hand movement of the user or a head movement of the user. For example, when the user shows the left hand, the gesture sensing unit senses the gesture and provides the feedback signal to the control unit generates an output signal via the left turn signal display.

A navigation unit is operationally coupled to the control unit. The navigation unit displays navigation events. In an embodiment, the navigation unit track the user as the journey progresses and prompt the user about current location, destination location, effective arrival time, upcoming turns, sights and traffic conditions. In another embodiment, the navigation unit provides navigation details to the user via haptic, visual display or audio signal.

An alarm unit is operationally coupled to an alarm unit. The alarm unit automatically produces an audio alarm signal to call for help when the user met with an accident or the helmet falls with the user to the ground. The helmet further comprise one or more speakers operationally coupled to the control unit. The one or more speakers enable the user to listen to music while using the helmet.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 shows a back view of the helmet with the turn signal indicator according to an embodiment.

FIG. 2 shows a perspective view of the helmet with the turn signal indicator according to an alternate embodiment.

FIG. 3 shows a block diagram of the helmet with the turn signal indicator according to an alternate embodiment.

### DETAILED DESCRIPTION OF EMBODIMENTS

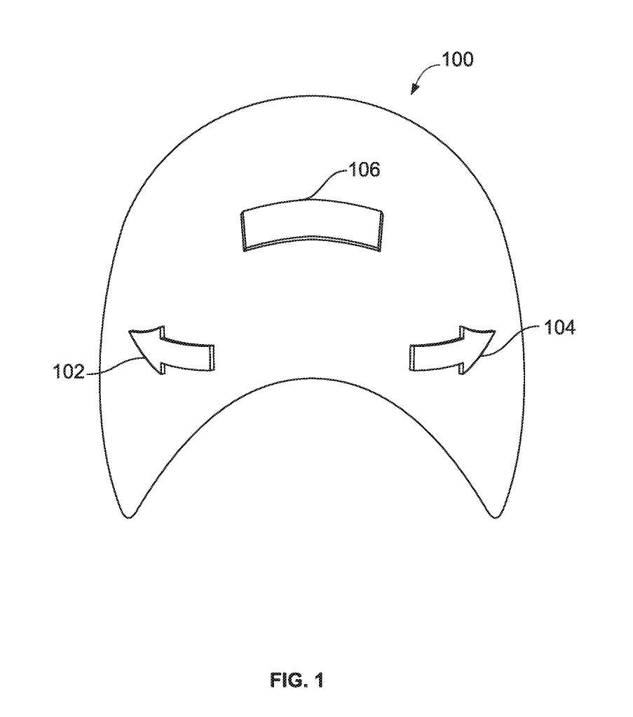

FIG. 1 exemplarily illustrates a back view of the helmet 100 with the turn signal indicator. The helmet 100 comprise a left turn signal display 102, a right turn signal display 104, a rear signal display 106, a front signal display (not shown), a power source unit (not shown), and a control unit (not shown). The left turn signal display 102 is located on the rear left of the helmet 100. The right turn signal display 104 is located on the rear right of the helmet 100. The rear signal display 106 is located on the backside of the helmet 100. The left turn signal display 102, the right turn signal display 104, the rear signal display 106, and the front signal display comprises an illumination means. In an embodiment, the illumination means includes, but not limited to a light emitting diode (LED), a light amplification by stimulated emission of radiation (LASER) lamp, a bulb, an incandescent lamp or one or more florescent materials.

The power source unit is configured to provide power to the left turn signal display 102, the right turn signal display 104, the rear signal display 106 and the front signal display. In an embodiment, the power source unit is a dry battery, a solar battery, renewable power sources or a rechargeable battery array. In an embodiment, the power source unit is operationally coupled to the control unit. In yet another embodiment, the power source unit is controlled by a power switch. The power switch enables the power source unit to be conserved when the helmet 100 is not in use by turning off the power switch.

In an embodiment, the power source unit includes a Universal Serial Bus (USB), an induction method, a wireless method for charging of the power source unit. In an embodiment, the power source unit includes an energy harvesting unit to store energy. In an embodiment, the energy harvesting unit is a solar battery, a rechargeable battery, or a battery array.

In an embodiment, the control unit is configured to control the left turn signal display 102, the right turn signal display 104, the rear signal display 106 and the front signal display. In one embodiment, the control unit controls the illumination means. In an embodiment, the control unit is operationally coupled to a power switch to control operations of both the rear signal display 106 and the front signal display manually by the user. In an embodiment, the power switch is installed on the top part of the helmet 100. In another embodiment, the power switch is an application installed on a mobile phone of the user. In another embodiment, mobile phone include, but are not limited to a cell phone, a cellular phone, a PDA, or a smart phone. In one embodiment, the control unit is operationally coupled to the mobile phone of the user via a communication unit. In another embodiment, the communication unit is Wi-Fi, Bluetooth, a wide area network, a radio network, a virtual private network, an internet area network, a metropolitan area network, a wireless network, or a telecommunication network.

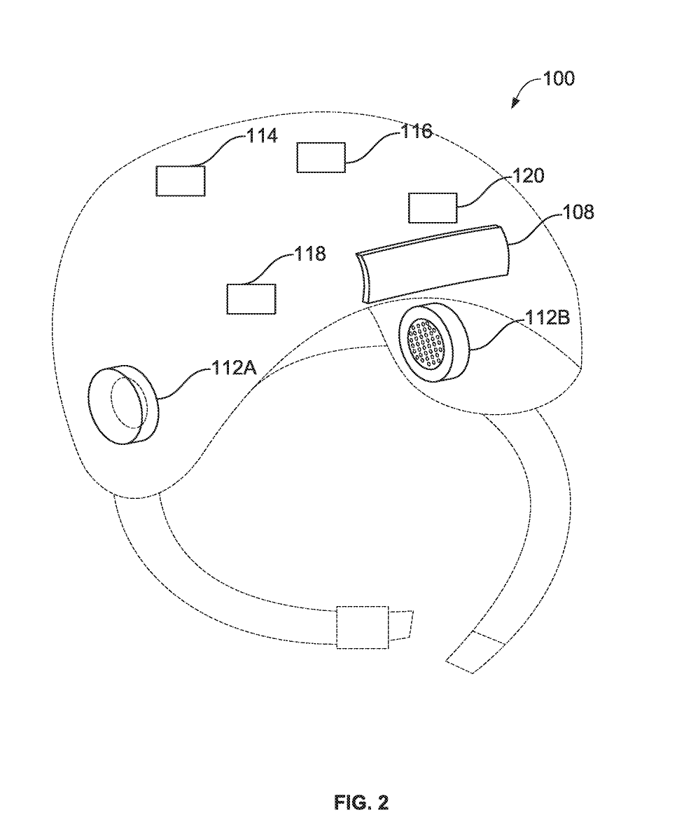

FIG. 2 shows a perspective view of the helmet 100 with the turn signal indicator. The helmet 100 further comprises the front signal display 108, and one or more speakers 112A-B. The front signal display 108 is located on the frontal part of the helmet 100. The front signal display 108 includes an illumination means. The one or more speakers 112A-B are operationally coupled to the control unit. The one or more speakers 112A-B enable the user to listen to music while using the helmet 100. In an embodiment, the one or more speakers are connected to a mobile phone of the user through a communication network. In another embodiment, the one or more speakers enable the user to communicate with the mobile phone for incoming calls and provide feedback like alerts to outside peoples.

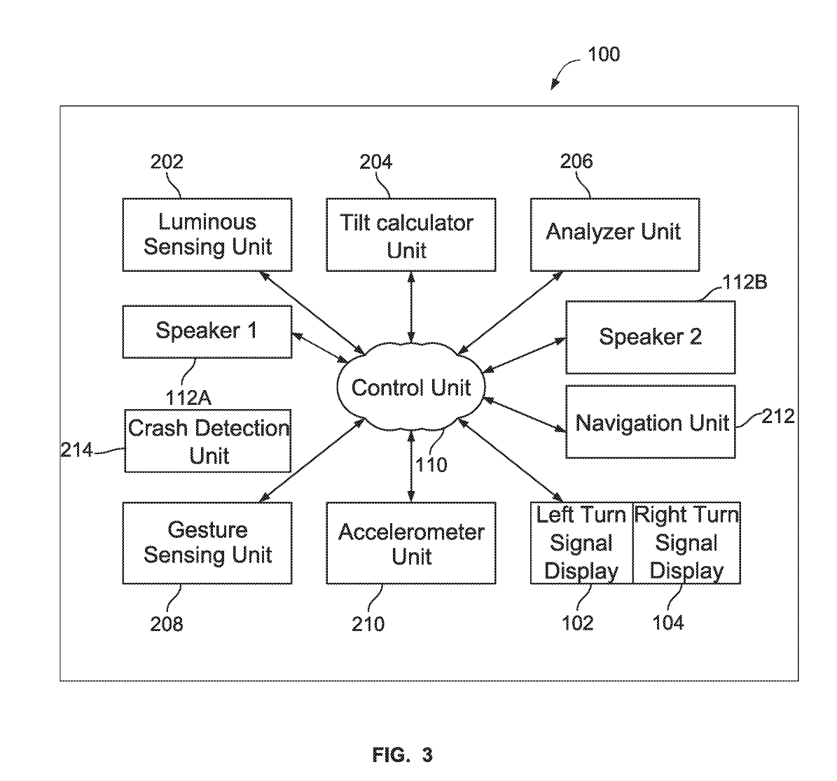

FIG. 3 shows a block diagram of the helmet 100 with turn signal indicator. The helmet 100 comprises the left turn signal display 102, the right turn signal display 104, the control unit 110, the one or more speakers 112A-B. The helmet 100 further comprises a luminous sensing unit 202, a tilt calculator unit 204, an analyzer unit 206, a gesture sensing unit 208, an accelerator unit 210, a navigation unit 212, an alarm unit (not shown), and a multifunctional module (not shown).

The luminous sensing unit 202 measures outdoor lighting conditions and provides a feedback signal to the control unit 110. The control unit 110 generates an output signal via the rear signal display 106 and the front signal display 108 based on the feedback signal generated by the luminous sensing unit 202. In an embodiment, the feedback signal is based on an outdoor lighting condition. In an embodiment, the control unit 110 control the rear signal display 106 and the front signal display 108 based on the outdoor lighting conditions. For example, when the outdoor lightning condition is poor, the luminous sensing unit 202 sends the feedback signal to the control unit 110 to turn on both the rear signal display 106 and the front signal display 108. When the outdoor lighting condition is good, the luminous sensing unit 202 sends the feedback signal to the control unit 110 to turn off both the rear signal display 106 and the front signal display 108.

In an embodiment, the tilt calculator unit 204 configured to calculate a tilt angle between axes of a vehicle to a surface. The tilt calculator unit 204 sends one or more data on the tilt angle to the control unit 110 through a feedback signal. The control unit 110 generates an output signal via the left turn signal display 102 and the right turn signal display 104 based on the feedback signal. The tilt calculator unit 204 comprise one or more sensors 114 to calculate the tilt angle. When the user tilts the vehicle towards the left of the surface, the tilt calculator unit 204 calculates the tilt angle and sends the one or more data on the tilt angle to the control unit 110 generates an output signal via the left turn signal display 102.

In an embodiment, the analyzer unit 206 configured to process a neuron behavior of the user. In one embodiment, the analyzer unit 206 configured to process multiple neuron behaviors of the user. In an embodiment, the analyzer unit 206 comprises a plurality of sensors 116 to sense neural activities of the user brain, and provides the one or more neural activities to the control unit 110. In one embodiment, the analyzer unit 206 is configured to measure real time electroencephalography (EEG) data of the user brain. The electroencephalography (EEG) measures voltage fluctuations resulting from ionic current within the neurons of the user brain. In an embodiment, the electroencephalography (EEG) comprise sensors/electrodes to measure electrical activities of the user brain. The control unit 110 generates an output signal via the left turn signal display 102 and the right turn signal display 104. In one embodiment, the plurality of sensors 116 is configured to sense multiple neural activities of the user brain. The plurality of sensors 116 of the analyzer unit 206 measures brainwaves of the user brain and transmits the brainwaves to the control unit 110 that converts the brainwaves into a format usable by a signal processor. In one embodiment, the analyzer unit 206 measures multiple brainwaves of the user brain and transmits at least two brainwaves to the control unit 110. The signal processor analyzes the brainwaves and sends a trigger signal to the control unit 110 generates an output signal via the left turn signal display 102 and the right turn signal display 104. In an embodiment, the trigger signal is based on the intensity of the brainwaves of the user. In another embodiment, the power source unit provides power to the control unit 110, speakers 112A-B, the navigation unit 212, the analyzer unit 206, and the alarm unit.

In an embodiment, the brainwaves associated with a particular mental and/or physical state of the user are classified to identify the particular mental and/or physical state of the user, and generates an alarm signal to notify the user. In an embodiment, patterns of the one or more brainwaves data is recorded and used for statistical analysis. In an embodiment, the analyzer unit 206 includes a spike sorting technique for analysis of the one or more neural activities of the user brain. In an embodiment, the analyzer unit 206 is operationally coupled to the gesture sensing unit 208. The one or more brainwaves are analyzed to predict the gesture of the user. In an embodiment, the one or more neuron behaviors of the user brain are processed by a processing unit. The processing unit are operationally coupled with the control unit 110.

In an embodiment, the gesture sensing unit 208 is operationally coupled to the control unit 110. The gesture sensing unit 208 senses different gestures of the user and provides a feedback signal to the control unit 110 generates an output signal via the left turn signal display 102 and the right turn signal display 104. The feedback signal is a hand movement of the user and/or a head movement of the user. In an embodiment, the control unit 110 controls both the left turn signal display 102 and the right turn signal display 104 based on the feedback signal from the gesture sensing unit 208. For example, when the user shows the left hand, the gesture sensing unit 208 senses the user gesture and provides the feedback signal to the control unit 110 generates an output signal via the left turn signal display 102.

In an embodiment, the accelerometer unit 210 operationally coupled to the control unit 110. The accelerometer unit 210 measures the acceleration of the vehicle and sends a feedback signal to the control unit 110. In an embodiment, the accelerometer unit 210 comprises an accelerometer sensors 118 to measure acceleration of the vehicle. The feedback signal is information on speed of the vehicle and/or information of braking condition of the vehicle. The control unit 110 generates an output signal via the rear signal display 106, if the accelerometer unit 210 measures the braking conditions of the vehicle. In an embodiment, the control unit 110 is operationally coupled to a braking system of the vehicle.

In one embodiment, the navigation unit 212 is operationally coupled to the control unit 110 to navigate the user. In an embodiment, the navigation unit 212 displays navigation events. The navigation unit 212 track the user as the journey progresses and prompt the user about current location, destination location, effective arrival time, upcoming turns, sights and traffic conditions. In an embodiment, the navigation unit 212 is a global positioning system (GPS) navigation module. In another embodiment, the navigation unit 212 provides voice navigation to the user. In an embodiment, travelling routes of the user is programmed or downloaded into the navigation unit before journey. In an embodiment, the navigation unit 212 provides navigation details to the user via haptic, visual display or audio signal.

In an embodiment, the alarm unit is operationally coupled to the control unit 110 to produce an audio alarm signal to call for help when the user met with an accident or the helmet 100 falls with the user to the ground. In an embodiment, the alarm unit produces the audio alarm signal through a buzzer when the user loses consciousness due to an accident.

In an embodiment, a crash detection unit 214 is operationally coupled to the control unit 110 to detect a crash of the vehicle. In one embodiment, the crash detection unit 214 comprises the accelerometer sensor 118, a plurality of proximity sensors 120, and/or a plurality of cameras. The crash detection unit 214 collects a plurality of feedback signals from the accelerometer sensor 118, a plurality of proximity sensors, 120 and/or a plurality of cameras and sends to the control unit 110. The control unit 110 is operationally connected to the mobile phone of the user through a communication network. The control unit 110 sends the plurality of feedback signals to the mobile phone of the user to call relatives of the user and sends an emergency code to a direct organization. In an embodiment, the direct organization is a rescue team, an organization predefined by the user, the police, or an ambulance service organization.

In an embodiment, the multifunctional module is operationally coupled to the control unit 110. The multifunctional module comprises a digital music player module, a FM broadcast module, and an AM broadcast module. In an embodiment, the multifunctional module is connected to the control unit 110 through the communication network. In another embodiment, the communication network includes, but not limited to, Wi-Fi, Bluetooth, a wide area network, a radio network, a virtual private network, an internet area network, a metropolitan area network, a wireless network, or a telecommunication network. In an embodiment, the telecommunication network includes, but not limited to, a global system for mobile communication (GSM) network, a general packet radio service (GPRS) network, a third Generation Partnership Project (3GPP), an enhanced data GSM environment (EDGE) or a Universal Mobile Telecommunications System (UMTS).

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A helmet with a turn signal display system, comprising:
a left turn signal display located to the rear left end of the helmet;
a right turn signal display located to the rear right end of the helmet;
a front signal display located to the frontal part of the helmet;
a rear signal display located to the rear part of the helmet;
a power source unit configured to provide power to the left turn signal display, the right turn signal display, the front signal display and the rear signal display;
a control unit configured to control the left turn signal display, the right turn signal display, the front signal display and the rear signal display;
a luminous sensing unit measures outdoor lighting conditions and provides a feedback signal to the control unit, wherein the control unit generates an output signal via the front signal display and the rear signal display based on the feedback signal;
a tilt calculator unit configured to calculate a tilt angle between axis of a vehicle to a surface, wherein the tilt calculator unit sends one or more data on the tilt angle to the control unit through a feedback signal, wherein the control unit generates an output signal via the left turn signal display and the right turn signal display based on the feedback signal; and
an analyzer unit configured to process one or more neuron behaviors of a user, comprising a plurality of sensors to sense one or more neural activities of the user brain, and provides the one or more neural activities to the control unit generates an output signal via the left turn signal display and the right turn signal display.

2. The helmet of claim 1, wherein the left turn signal display, the right turn signal display, the front signal display and the rear signal display comprises an illumination means.

3. The helmet of claim 2, wherein the illumination means comprises a light emitting diode, a light amplification by stimulated emission of radiation lamp, a bulb, or an incandescent lamp.

4. The helmet of claim 1, wherein the luminous sensing unit is operationally connected to the control unit, wherein the control unit turns on the front signal display and the rear signal display when the outdoor lighting condition is poor, wherein the control unit turns off the front signal display and the rear signal display when the outdoor lighting condition is good.

5. The helmet of claim 1, wherein the tilt calculator unit comprise one or more sensors to calculate the tilt angle, wherein when the user tilts the vehicle towards the left of the surface, the tilt calculator unit calculates the tilt angle and sends the one or more data on the tilt angle to the control unit generates an output signal via the left turn signal display.

6. The helmet of claim 1, wherein the plurality of sensors of the analyzer unit measures one or more brainwaves of the user brain and transmits at least two brainwaves to the control unit that converts the brainwaves into a format usable by a signal processor.

7. The helmet of claim 6, wherein the signal processor analyzes the brainwaves and sends a trigger signal to the control unit generates an output signal via the left turn signal display and the right turn signal display, wherein the trigger signal is based on the intensity of the brainwaves of the user.

8. The helmet of claim 6, wherein the brainwaves associated with a particular mental or physical state of the user are classified to identify the particular mental or physical state of the user, and generates an alarm signal to notify the user.

9. The helmet of claim 1, further comprises an accelerometer unit operationally coupled to the control unit, wherein the accelerometer unit measures the acceleration of the vehicle and sends a feedback signal to the control unit, wherein the feedback signal is information on speed of the vehicle and information of braking condition of the vehicle.

10. The helmet of claim 9, wherein the control unit generates an output signal via the rear signal display, if the accelerometer unit measures the braking conditions of the vehicle.

11. The helmet of claim 1, further comprises a gesture sensing unit is operationally coupled to the control unit, wherein the gesture sensing unit senses different gestures of the user and provides a feedback signal to the control unit generates an output signal via the left turn signal display and the right turn signal display, wherein the feedback signal is a hand movement of the user or a head movement of the user.

12. The helmet of the claim 11, wherein when the user shows the left hand, the gesture sensing unit senses the gesture and provides the feedback signal to the control unit generates an output signal via the left turn signal display.

13. The helmet of the claim 1, wherein the control unit is operationally coupled to a navigation unit, wherein the navigation unit displays navigation events, wherein the navigation unit track the user as the journey progresses and prompt the user about current location, destination location, effective arrival time, upcoming turns, sights and traffic conditions.

14. The helmet of claim 13, wherein the navigation unit provides navigation details to the user via haptic, visual display or audio signal.

15. The helmet of claim 1, wherein the control unit is operationally coupled to an alarm unit, wherein the alarm unit automatically produces an audio alarm signal to call for help when the user met with an accident or the helmet falls with the user to the ground.

16. The helmet of claim 1, further comprise one or more speakers operationally coupled to the control unit, wherein the one or more speakers enable the user to listen to music while using the helmet.

17. The helmet of claim 16, wherein the one or more speakers are connected to a mobile phone of the user through a communication network, wherein the one or more speakers enable the user to communicate with the mobile phone for incoming calls and provide feedback to outsiders.

18. The helmet of claim 1, wherein the power source unit is a dry battery, a solar battery, renewable power sources or a rechargeable battery array.
